(19) United States
(12) Patent Application Publication
(10) Pub. No.: US 2025/0246848 A1
(43) Pub. Date: Jul. 31, 2025

(54) HIGH CURRENT CONNECTOR

(71) Applicant: BIZLINK INTERNATIONAL CORP., New Taipei City (TW)

(72) Inventors: Xiangwu WANG, New Taipei City (TW); Chubei ZHANG, New Taipei City (TW); Zhongming LIN, New Taipei City (TW)

(21) Appl. No.: 18/641,361

(22) Filed: Apr. 20, 2024

(30) Foreign Application Priority Data
Jan. 31, 2024 (CN) 202410137132.2

(51) Int. Cl. H01R 13/53

(52) U.S. Cl. CPC H01R 13/53

(57) ABSTRACT

A high current connector includes a base, at least one terminal and at least one insulating piece. The base has an inner wall defining a passage. The terminal is disposed in the passage. The insulating piece is disposed in the passage. The insulating piece is at least partially located between the terminal and the inner wall. A front end of the insulating piece exceeds a front end of the terminal.

### RELATED APPLICATIONS

This application claims priority to Chinese Application Serial Number CN202410137132.2, filed Jan. 31, 2024, which is herein incorporated by reference in its entirety.

### BACKGROUND

### Technical Field

The present disclosure relates to connectors. More particularly, the present disclosure relates to high current connectors.

### Description of Related Art

An electric arc is an instantaneous spark phenomenon formed when an electric current passes through an insulating medium (such as air) under normal condition when plasma is continuously formed by electric collapse of a gas due to an excessive strength of an electric field. Electric arc is common in the process of plugging and unplugging of a connector and will cause the following risks:
(1) Electric arcs formed after a male connector and a female connector are electrically plugged and unplugged many times may cumulatively consume and finally break through a side wall of the base of the connector, causing danger; and
(2) When a male connector and a female connector are electrically separated from each other, an electric arc may be formed therebetween, causing severe safety risks.

### SUMMARY

A technical aspect of the present disclosure is to provide a high current connector, which can improve the safety performance during the process of plugging and unplugging and avoid the risk caused by an electric arc.

According to an embodiment of the present disclosure, a high current connector includes a base, at least one terminal and at least one insulating piece. The base has an inner wall defining a passage. The terminal is disposed in the passage. The insulating piece is disposed in the passage. The insulating piece is at least partially located between the terminal and the inner wall. A front end of the insulating piece exceeds a front end of the terminal.

In one or more embodiments of the present disclosure, the insulating piece covers at least a portion of the inner wall located between the terminal and a front opening of the passage.

In one or more embodiments of the present disclosure, the insulating piece has a plurality of grooves. The grooves are arranged along an extension direction of the insulating piece. The grooves are located at the front end of the insulating piece proximal to the front opening of the passage.

In one or more embodiments of the present disclosure, the grooves are respectively perpendicular to an extension direction of the terminal.

In one or more embodiments of the present disclosure, the insulating piece has a protruding platform. The protruding platform is located at the front end of the insulating piece. The grooves are formed on an upper surface of the protruding platform.

In one or more embodiments of the present disclosure, the insulating piece is a ceramic piece.

In one or more embodiments of the present disclosure, the passage of the base has an upper accommodation trough and a lower accommodation trough. The lower accommodation trough is communicated with the upper accommodation trough. The terminal is embedded in the upper accommodation trough. The insulating piece is embedded in the lower accommodation trough.

In one or more embodiments of the present disclosure, a width of the terminal matches with a width of the upper accommodation trough.

In one or more embodiments of the present disclosure, a width of the insulating piece matches with a width of the lower accommodation trough.

In one or more embodiments of the present disclosure, a maximum width of the lower accommodation trough is larger than a maximum width of the upper accommodation trough.

In one or more embodiments of the present disclosure, the upper accommodation trough and the lower accommodation trough have a shape of reverse “T” at a front end surface of the base defining a front opening of the passage.

In one or more embodiments of the present disclosure, a front end surface of the insulating piece faces to and is entirely exposed from a front opening of the passage. The front end surface of the insulating piece is free from blockage by the base.

In one or more embodiments of the present disclosure, a front end surface of the insulating piece aligns with a front end surface of the base defining a front opening of the passage.

In one or more embodiments of the present disclosure, a width of the terminal is larger than a thickness of the terminal.

According to an embodiment of the present disclosure, a high current connector includes a base, at least one terminal and at least one insulating piece. The base has an inner wall defining a passage. The terminal is disposed in the passage. The insulating piece is disposed in the passage. The insulating piece is at least partially located between the terminal and the inner wall. A front end surface of the terminal faces to and is entirely exposed from a front opening of the passage. The front end surface of the terminal is free from blockage by the insulating piece.

The above-mentioned embodiments of the present disclosure have at least the following advantages:
(1) By disposing at least one insulating piece in the passage of the base, and covering at least a portion of the inner wall of the passage located between the terminal and a front opening of the passage by the insulating piece, the electric arc strike generated by the connector during the plugging and unplugging process can be prevented from breaking through the hot spot of strike of the wall surface of the passage, such that the safety performance of the high current connector is improved.
(2) By disposing at least one groove on the inner wall of the passage between the terminal and the front opening of the passage, the feasible paths of an electric arc are increased when separating two connectors in electric connection, such that the electric arc is unlikely to be sprayed out of the front opening of the passage, and the safety performance of the high current connector is improved.

### BRIEF DESCRIPTION OF THE DRAWINGS

The disclosure can be more fully understood by reading the following detailed description of the embodiments, with reference made to the accompanying drawings as follows:

FIG. 1 is a schematic view of a high current connector according to a first embodiment of the present disclosure;

FIG. 2 is an exploded view of the high current connector of FIG. 1;

FIG. 3 is a front view of the high current connector of FIG. 1;

FIG. 4 is a sectional view along the sectional line A-A of FIG. 3;

FIG. 5 is a schematic view of a high current connector according to a second embodiment of the present disclosure;

FIG. 6 is a front view of the high current connector of FIG. 5;

FIG. 7 is a sectional view along the sectional line B-B of FIG. 6;

FIG. 8 is a schematic view of a high current connector according to a third embodiment of the present disclosure;

FIG. 9 is a front view of the high current connector of FIG. 8; and

FIG. 10 is a sectional view along the sectional line C-C of FIG. 9.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

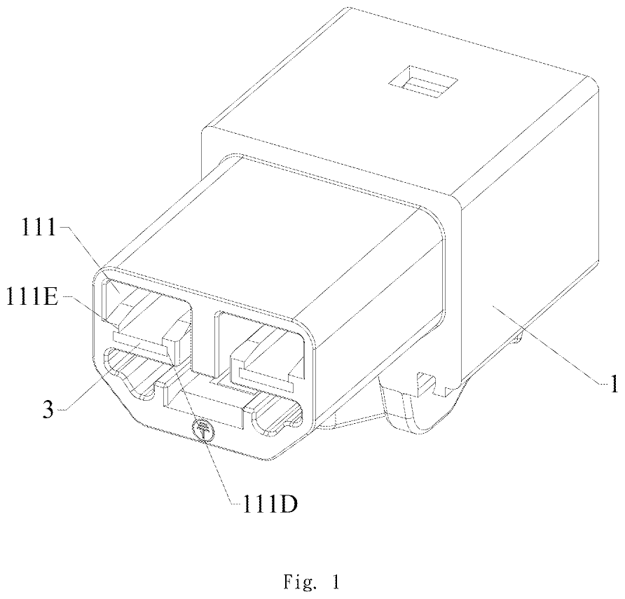

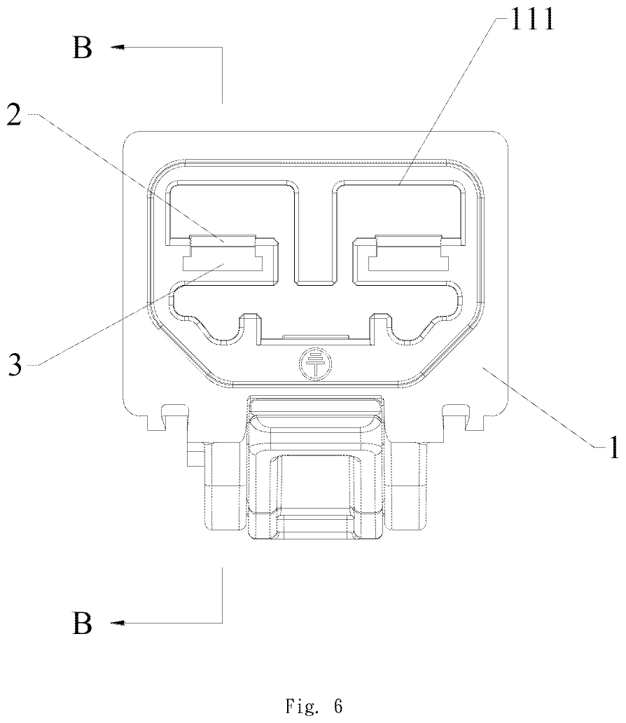

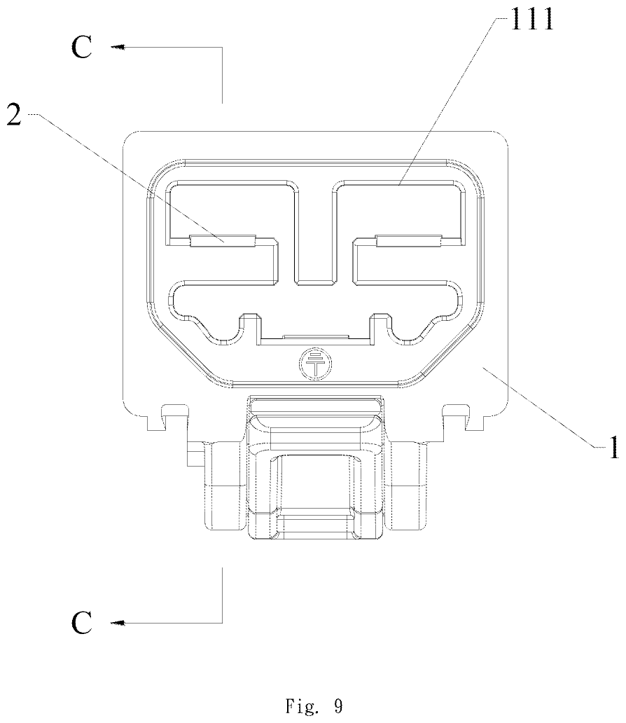

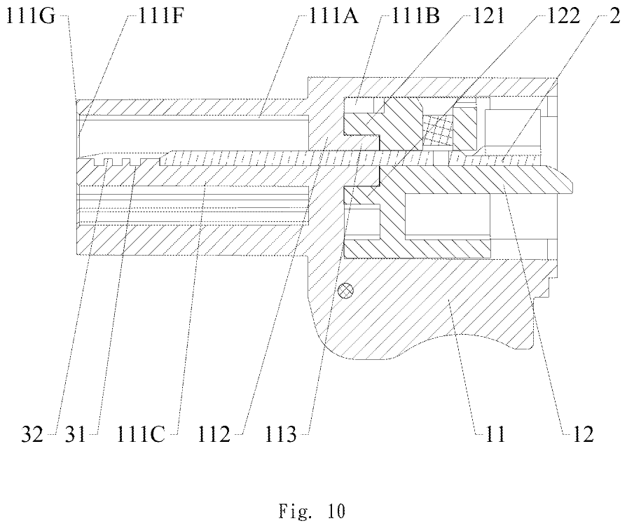

FIGS. 1-10 are drawn according to the actual scale. For the sake of concise description in this specification, the scales of the elements are not listed one by one. However, the scale and position of each element should be regarded as part of the scope of this specification.

Reference is made to FIGS. 1-4. In this first embodiment, a high current connector is disclosed. The high current connector includes a base 1, at least one terminal 2 and at least one insulating piece 3. The base 1 mainly includes an outer mold 11 and an inner mold 12.

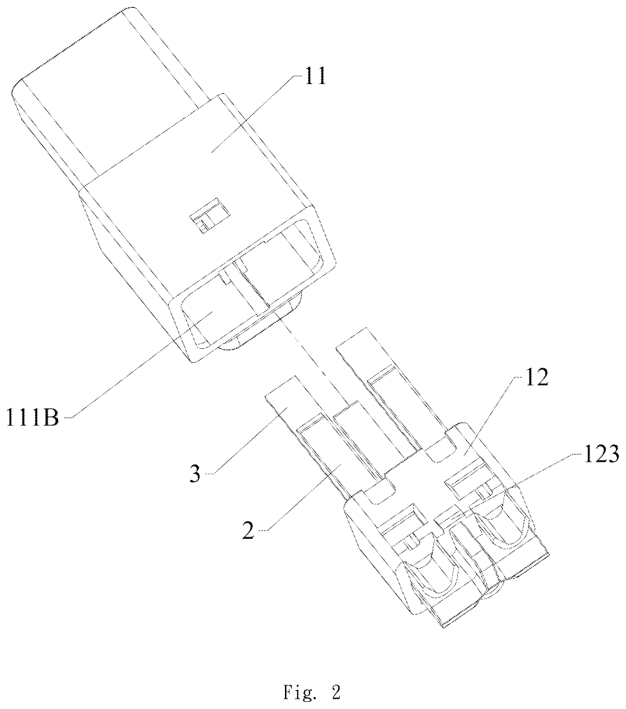

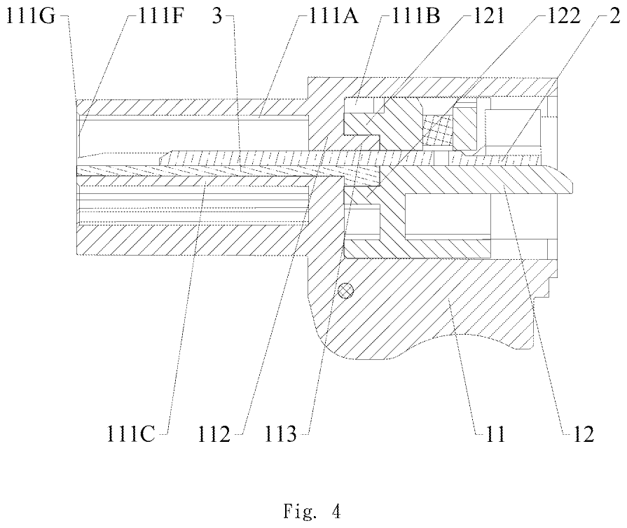

As shown in FIG. 2, the outer mold 11 is a one-piece element. The outer mold 11 is mainly formed of materials resistant to heat and electric arc, such as nylon. As shown in FIG. 1, the outer mold 11 has two passages 111 located on an upper side and one passage 111 located on the lower side. The passage 111 located on the lower side is at the same time communicated with the two passages 111 located on the upper side. The two passages 111 located on the upper side are respectively configured to accommodate a positive terminal 2 and a negative terminal 2. The passage 111 located on the lower side is configured to accommodate a ground terminal 2. Two signal terminal chambers are respectively disposed on the left and the right side of the passage 111 located on the lower side. The signal terminal chambers are an option for plugging a signal terminal therein. However, the signal terminal chambers are not a key point of the present disclosure and are not described in details herein. Taking FIG. 4 as an example, different regions of each of the passages 111 can be divided into two portions of a working chamber 111A located at the front end and a connecting chamber 111B located at the rear end, according to the positions. The working chamber 111A and the connecting chamber 111B are formed by an isolation of a middle wall 112 located in the middle of the corresponding one of the passages 111. The middle wall 112 has a hole. Moreover, a positioning protrusion 113 is extended from the middle wall 112 at an edge of the hole.

As shown in FIG. 4, the middle wall 112 is a portion of the outer mold 11 and is integrally formed with the outer mold 11 from a single piece of material. The working chamber 111A and the connecting chamber 111B are respectively located at the front (the left side of FIG. 4) and the back (the right side of FIG. 4) of the passage 111 along a plugging direction, an extension direction of the terminal 2 or a length direction of the terminal 2.

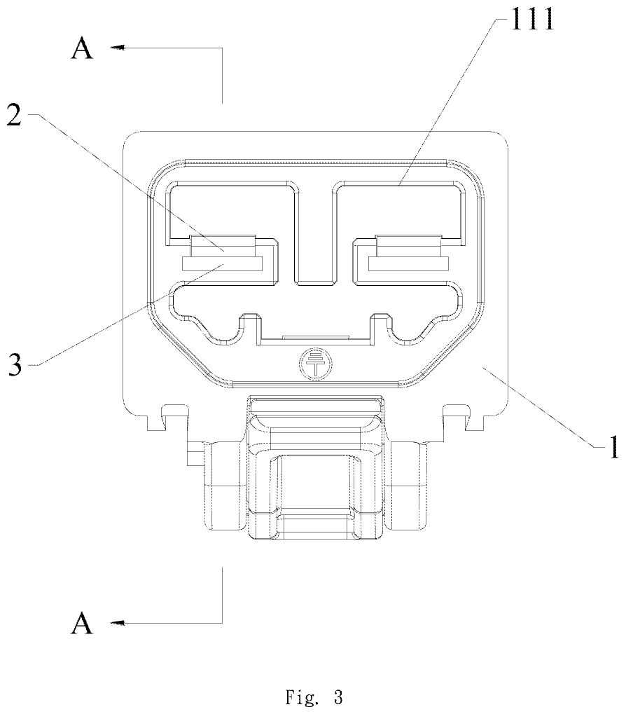

As shown in FIG. 4, a bottom portion of each of the two passages 111 located at the upper side has an inner wall used to support the terminal 2 and the insulating piece 3. The inner wall is known as a supporting wall 111C. The supporting wall 111C has a lower accommodation trough 111D which is relatively wide and an upper accommodation trough 111E which is relatively narrow. The upper accommodation trough 111E and the lower accommodation trough 111D respectively extend from the front end surface 111G of the front opening 111F of the passage 111 to the connecting chamber 111B through the working chamber 111A. As viewed from the left to the right of FIG. 4, the upper accommodation trough 111E and the lower accommodation trough 111D have roughly a shape of reverse “T” at the front end surface 111G of the base 1 defining the front opening 111F of the passage 111, as shown in FIG. 3.

As shown in FIG. 2 and FIG. 4, the inner mold 12 is an insulating material layer in a one-piece form. In this first embodiment, the material of the inner mold 12 is the same as the material of the outer mold 11. In other embodiments, the material of the inner mold 12 and the material of the outer mold 11 can be different. The inner mold 12 has a through hole penetrating through the front and the back. The inner mold 12 has an upper protruding portion 121 and a lower protruding portion 122 respectively located at the upper side and the lower side of the front end surrounding the through hole.

As shown in FIG. 4, in this embodiment, the terminal 2 is used for power supply. To be specific, the terminal 2 is a roughly rectangular columnar metal terminal made of copper. The width of the terminal 2 matches with the width of the upper accommodation trough 111E as mentioned above. The matching of A with B means the larger value of A and B is about 100%-105% of the smaller value of A and B. The terminal 2 has a guiding angle at the front end. The maximum thickness of the terminal 2 in a vertical direction of FIG. 4 is larger than 1 mm. To be specific, the maximum thickness of the terminal 2 can be 1.2 mm, 1.5 mm or thicker. In this first embodiment, the width of the terminal 2 is larger than the thickness of the terminal 2. The terminal 2 has a through hole at the rear end, in which the through hole is used for allowing a cable to penetrate through and then to be welded thereon. However, in other embodiments, different designs can be adopted for the terminal 2. For example, an elastically bendable terminal 2 making use of its elastic spring below can be adopted. When an elastically bendable terminal 2 is adopted, as an option, the outer mold 11 does not have any accommodation trough, and the elastically bendable terminal 2 is directly supported on a flat surface of the passage 111.

As shown in FIG. 2, in this embodiment, the insulating piece 3 is itself an insulating material in a one-piece form and is not integrally formed with the base 1. The material of the insulating piece 3 and the material of the outer mold 11 are different. To be specific, the insulating material can be ceramic material or other material, which is resistant to electric arc, the same as or different from the material of the outer mold 11. Moreover, the insulating piece 3 is practically shaped as a slat or a thin elongated column with a substantially rectangular cross-section. Furthermore, the front end of the insulating piece 3 is roughly in a shape of a uniform rectangular column. The rear end of the insulating piece 3 is another rectangular column thicker than the front end. The width of the insulating piece 3 matches with the width of lower accommodation trough 111D as mentioned above.

The manufacturing method of the connector is described below.

Taking the design in the first embodiment as an example. First of all, the outer mold 11 and the inner mold 12 are respectively formed by injection molding. Then, two insulating pieces 3 are respectively inserted into the lower accommodation troughs 111D of the two passages 111 located on the upper side of the outer mold 11, until the rear end, which is relatively thick, of each of the insulating pieces 3 abuts against the surface of the middle wall 112 of the outer mold 11. Then, other elements including the terminals 2 are inserted into the inner mold 12 and fixed by methods such as mechanisms, adhesives or external fixing elements. Then, the inner mold 12 together with each of the elements including the terminals 2 are pushed into the connecting chamber 111B of the outer mold 11, such that the upper protruding portion 121 and the lower protruding portion 122 of the inner mold 12 are sleeved to the positioning protrusion 113 of the outer mold 11 and the end portion of each of the insulating pieces 3, and an anti-withdrawal hook 123 on a surface of the inner mold 12 is snapped to the through hole of the outer mold 11 to fix the positions of the inner mold 12 and the outer mold 11. In this way, the manufacture of the connector of the present disclosure is completed. During application, after a cable is welded to the through hole of each of the terminals 2, a coverage material layer is formed outside the connector together with the cable by insert molding, and the finished product of wiring harness is formed.

As shown in FIG. 4, after the assembly of the connector is completed, the insulating piece 3 is supported on the supporting wall 111C. The terminal 2 is stacked on the insulating piece 3. The front end of the insulating piece 3 exceeds the front end of the terminal 2. The insulating piece 3 covers at least a portion of the supporting wall 111C of the passage 111 located between the terminal 2 and the front opening 111F of the passage 111. This can resist the electric arc strike generated by the connector during the plugging and unplugging process, thereby preventing the supporting wall 111C of the passage 111 of the outer mold 11 from being broken through, such that the safety performance of the high current connector can be higher.

Moreover, as shown in FIG. 4, the terminal 2 covers at least a portion of the insulating piece 3. The insulating piece 3 is at least partially sandwiched between the terminal 2 and the supporting wall 111C.

In addition, it is worth to note that, in this first embodiment, the terminal 2 is placed on the insulating piece 3 in a flat manner. The whole body and the front end surface of the terminal 2 are not embedded in the insulating piece 3. This means, the front end surface of the insulating piece 3 faces to and is entirely exposed from the front opening 111F of the passage 111. The front end surface of the terminal 2 is free from blockage by the insulating piece 3. It is understood that, as viewed from the left side to the right side of FIG. 4, the entire front end surface of the terminal 2 can be seen. Moreover, the front end surface of the insulating piece 3 faces to and is entirely exposed from the front opening 111F of the passage 111. The front end surface of the insulating piece 3 is free from blockage by the base 1. The front end surface of the insulating piece 3 and the front end surface of the outer mold 11 are substantially aligned with each other. The definition of substantial alignment is that the front end surface of the insulating piece 3 is shifted inside or protruded outside relative to the front end surface of the outer mold 11 by less than 5 mm. It is understood that, as viewed from the left side to the right side of FIG. 3, the whole of the front end surface of the insulating piece 3 can be seen. Correspondingly, the insulating piece 3 can basically cover over 95% of the supporting wall 111C between the terminal 2 and the front opening 111F of the passage 111, at the right front region of the terminal 2. As described in another angle, as shown in FIG. 3, two hanging walls are respectively extended from the left and the right of the outer mold 11 to the central region. Each of the hanging walls is of a roughly U-shape for supporting the terminal 2 and the insulating piece 3.

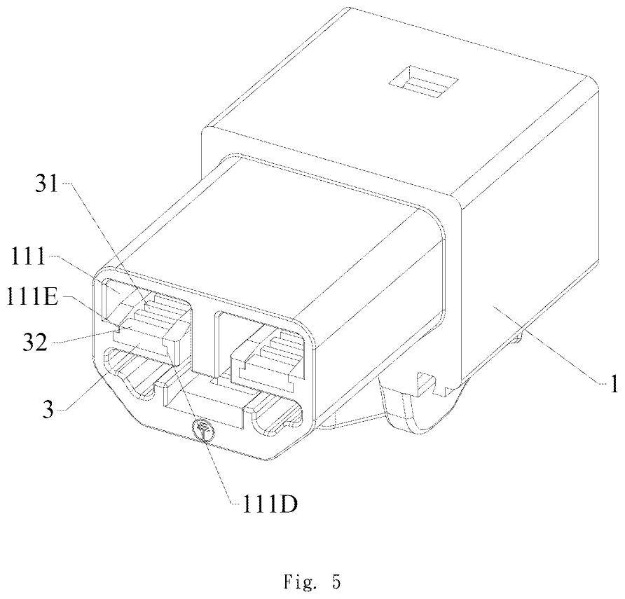

In this embodiment, the insulating piece 3 is shaped as a flat plate. According to the actual situations, the insulating piece 3 can be adjusted to a U-shape, such that two stopping walls are respectively disposed on the left side wall and the right side wall of the terminal 2, in order to further isolate between the terminal 2 and the outer mold 11. Reference is made to FIGS. 5-7, which is the second embodiment of the present disclosure. The second embodiment is modified from the foundation of the first embodiment.

In the second embodiment, the insulating piece 3 has at least one groove 31 located at the front end of the insulating piece 3 proximal to the front opening 111F of the passage 111. Furthermore, the extension direction of the groove 31 is perpendicular to the length direction of the passage 111. When a quantity of the groove 31 is plural, the grooves 31 are parallel with each other and evenly distributed along the length direction of the passage 111. In the presence of the grooves 31 or similar recess structures arranged along from the front to the back, provided that each of the grooves 31 is not parallel with the extension direction of the terminal 2, the chance to produce an electric arc is reduced to a certain extent. The more the quantity of the grooves 31, the better the effect will be. Moreover, the shape of each of the grooves 31 needs not to be of a long recess. According to the actual situations, each of the grooves 31 can be a circular hole or a recess of other shape, which can also provide corresponding effect. In addition, distances between the grooves 31 are not necessary to be equal.

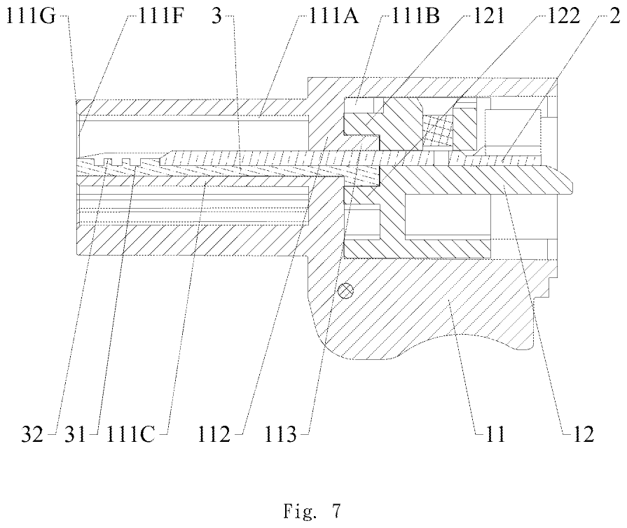

For example, as shown in FIG. 7, the insulating piece 3 has a protruding platform 32. The protruding platform 32 is located at the front end of the insulating piece 3. The grooves 31, which extend in a direction perpendicular to the inserting direction, are formed on an upper surface of the protruding platform 32. The grooves 31 are not restricted to be disposed on the protruding platform 32. According to the actual situations, the grooves 31 can be directly formed downwards on the flat region at the front end of the insulating piece 3 of FIG. 4. Moreover, if another connector to be connected also has a corresponding design of the grooves 31, the effect will be better.

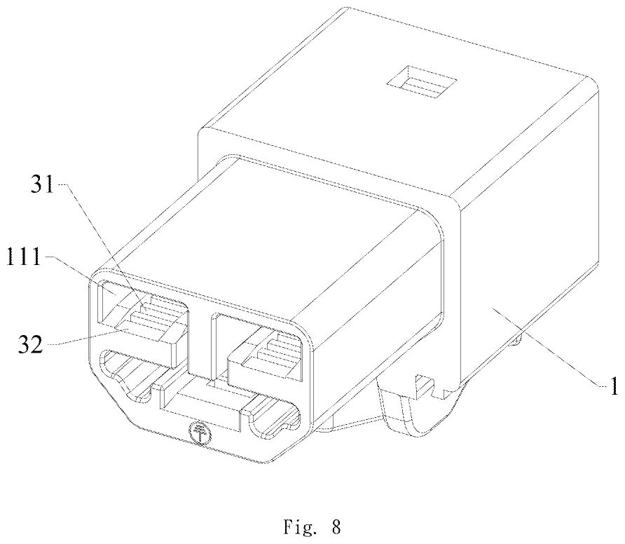

Reference is made to FIGS. 8-10, which is the third embodiment of the present disclosure. A high current connector is disclosed. The difference of the third embodiment from the first embodiment is that the insulating piece 3 is not included and the grooves 31 are respectively disposed on the protruding platform 32 on the supporting wall 111C in each of the passages 111 of the outer mold 11 near the opening. According to the actual situations, the grooves 31 can be directly formed on the supporting wall 111C and the protruding platform 32 is not required.

In summary, in the present disclosure, the supporting wall 111C is disposed with at least one groove 31 located between the terminal 2 and the front opening 111F of the passage 111, such that feasible paths of an electric arc are increased, and more consumption of the electric arc can be made in the process when the electric arc is produced and moved to the front opening 111F of the passage 111. This means the electric arc is unlikely to be sprayed out of the front opening 111F of the passage 111, and the risk caused by breaking through the air is avoided.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A high current connector, comprising:
a base having an inner wall defining a passage;
at least one terminal disposed in the passage; and
at least one insulating piece disposed in the passage and at least partially located between the terminal and the inner wall, and a front end of the insulating piece exceeding a front end of the terminal.

2. The high current connector of claim 1, wherein the insulating piece covers at least a portion of the inner wall located between the terminal and a front opening of the passage.

3. The high current connector of claim 2, wherein the insulating piece has a plurality of grooves arranged along an extension direction of the insulating piece and located at the front end of the insulating piece proximal to the front opening of the passage.

4. The high current connector of claim 3, wherein the grooves are respectively perpendicular to an extension direction of the terminal.

5. The high current connector of claim 4, wherein the insulating piece has a protruding platform located at the front end of the insulating piece, the grooves are formed on an upper surface of the protruding platform.

6. The high current connector of claim 1, wherein the insulating piece is a ceramic piece.

7. The high current connector of claim 1, wherein the passage of the base has an upper accommodation trough and a lower accommodation trough communicated with the upper accommodation trough, the terminal is embedded in the upper accommodation trough, and the insulating piece is embedded in the lower accommodation trough.

8. The high current connector of claim 7, wherein a width of the terminal matches with a width of the upper accommodation trough.

9. The high current connector of claim 7, wherein a width of the insulating piece matches with a width of the lower accommodation trough.

10. The high current connector of claim 7, wherein a maximum width of the lower accommodation trough is larger than a maximum width of the upper accommodation trough.

11. The high current connector of claim 7, wherein the upper accommodation trough and the lower accommodation trough have a shape of reverse “T” at a front end surface of the base defining a front opening of the passage.

12. The high current connector of claim 1, wherein a front end surface of the insulating piece faces to and is entirely exposed from a front opening of the passage, and the front end surface of the insulating piece is free from blockage by the base.

13. The high current connector of claim 1, wherein a front end surface of the insulating piece aligns with a front end surface of the base defining a front opening of the passage.

14. The high current connector of claim 1, wherein a width of the terminal is larger than a thickness of the terminal.

15. A high current connector, comprising:
a base having an inner wall defining a passage;
at least one terminal disposed in the passage; and
at least one insulating piece disposed in the passage and at least partially located between the terminal and the inner wall, a front end surface of the terminal facing to and being entirely exposed from a front opening of the passage, and the front end surface of the terminal being free from blockage by the insulating piece.
